(19) United States
(12) Patent Application Publication
(10) Pub. No.: US 2026/0309211 A1
(43) Pub. Date: Oct. 8, 2026

(54) BALL SCREW DEVICE

(71) Applicant: NSK LTD., Tokyo (JP)

(72) Inventors: Akihiro WATANABE, Kanagawa (JP); Yasumi WATANABE, Kanagawa (JP); Kazuya YAMADA, Kanagawa (JP)

(73) Assignee: NSK LTD., Tokyo (JP)

(21) Appl. No.: 19/480,601

(22) PCT Filed: Apr. 5, 2024
(86) PCT No.: PCT/JP2024/014081

§ 371 Date: Oct. 31, 2025

(30) Foreign Application Priority Data
May 9, 2023 (JP) 2023-077324

(51) Int. Cl. F16H 25/22

(52) U.S. Cl. CPC F16H 25/2223

(57) ABSTRACT

A ball screw device of the present disclosure includes a nut, a screw shaft, balls, and at least one deflector. An outer peripheral surface of the screw shaft is provided with at least one recess that accommodates the deflector. On an inner peripheral surface of the recess, two screw shaft openings are provided in an outer peripheral raceway surface, and the screw shaft openings are opened toward the deflector. The deflector includes a pair of deflector openings opened in an outer peripheral surface of the deflector and connected to the screw shaft openings, a circulation groove surface connected to each deflector opening and having an internal space forming a circulation pathway, and a pair of tongues disposed radially outside the circulation groove surface and protruding toward the deflector openings. A tip of the tongue is disposed radially outside a virtual spiral connecting centers of the balls rolling on the raceway.

### FIELD

The present disclosure relates to a ball screw device.

### BACKGROUND

A ball screw device includes a nut, a screw shaft inserted into the nut, a plurality of balls disposed between the nut and the screw shaft, and a circulation component. An inner peripheral raceway surface is formed on an inner peripheral surface of the nut. An outer peripheral raceway surface facing the inner peripheral raceway surface is formed on an outer peripheral surface of the screw shaft. A spiral raceway is formed between the inner peripheral raceway surface and the outer peripheral raceway surface. The plurality of balls is arranged on a raceway and moves in a spiral direction along the raceway. Then, the circulation component returns, to one end of the raceway, the ball moved from the one end of the raceway to the other end of the raceway. One example of the circulation component is a deflector that returns the balls by one lead.

In a ball screw device disclosed in Patent Literature below, a recess that is recessed radially inward is formed on the outer peripheral surface of the screw shaft. The deflector is inserted into the recess and attached to the screw shaft. The deflector includes an outer diameter surface facing radially outward and a circulation groove surface recessed radially inward from the outer diameter surface. The circulation groove surface is an S-shaped groove surface having an S-shape when viewed from a radial outside. The ball moves radially inward within the S-shaped groove surface of the deflector and rides over a thread of a nut.

### CITATION LIST

### Patent Literature

Patent Literature 1: JP 2004-225770 A

### SUMMARY

### Technical Problem

However, according to the deflector of the above patent literature, when the ball moves radially inward, the ball may be caught between the S-shaped groove surface (circulation groove surface) and the inner peripheral raceway surface of the nut. Therefore, smooth rolling of the ball is not ensured. In addition, when the ball is caught, a groove shoulder of the S-shaped groove surface (circulation groove surface) may get damaged.

The present disclosure has been made in view of the above, and an object of the present disclosure is to provide a ball screw device that is capable of smoothly rolling balls and preventing a breakage of the deflector.

### Solution to Problem

A ball screw device according to an embodiment of the present disclosure includes: a nut that has an inner peripheral raceway surface on an inner peripheral surface; a screw shaft that is inserted into the nut and has an outer peripheral raceway surface on an outer peripheral surface; a plurality of balls disposed on a raceway between the outer peripheral raceway surface and the inner peripheral raceway surface; and at least one deflector that circulates the plurality of balls. The outer peripheral surface of the screw shaft is provided with at least one recess that is recessed radially inward and accommodates the deflector. The recess has an inner peripheral surface provided with two screw shaft openings in the outer peripheral raceway surface, the two screw shaft openings opened toward the deflector. The deflector includes: a pair of deflector openings opened in an outer peripheral surface of the deflector and connected to the two screw shaft openings, a circulation groove surface that is connected to each of the pair of deflector openings and has an internal space forming a circulation pathway, and a pair of tongues disposed radially outside the circulation groove surface and protruding toward the pair of deflector openings. The pair of tongues each has a tip disposed radially outside a virtual spiral connecting centers of the plurality of balls rolling on the raceway.

According to the present disclosure, a ball that has entered a deflector opening from an outer peripheral raceway surface comes into contact with a tip of a tongue. The tip of the tongue is in contact with a portion of the ball on a radially outer side from a ball center. As a result, a travel pathway of the ball changes to a radially inner side, and the ball reliably moves radially inward. Therefore, it is avoided that the ball is caught between the circulation groove surface and the inner peripheral raceway surface of the nut, and smooth rolling of the ball is secured. In addition, a breakage of the groove shoulder of the circulation groove surface is avoided.

Furthermore, in a preferred aspect of the above-described ball screw device, the pair of tongues each has an inner diameter surface facing radially inward. The inner diameter surface is tilted so as to be gradually positioned radially inward as a distance from the tip increases.

According to the above configuration, the ball is guided radially inward along a sloped surface after coming into contact with the tip of the tongue. Therefore, the ball smoothly moves radially inward.

Furthermore, in a preferred aspect of the above-described ball screw device, the tip is disposed on the inner peripheral raceway surface of the nut.

According to the above configuration, an amount of step between the tip of the tongue and the inner peripheral raceway surface is small. Therefore, it is avoided that the ball is caught by the tip of the tongue (movement stopped).

Furthermore, the circulation groove surface of the above-described ball screw device is an S-shaped groove surface formed in an S-shape. The S-shaped groove surface includes: a spiral area disposed near each of the pair of deflector openings and extending along a spiral direction in which the raceway extends, and a bent area adjacent to the spiral area and gradually deviating from the spiral direction. The tip is disposed radially outside with respect to the spiral area.

Furthermore, the circulation groove surface of the above-described ball screw device is an S-shaped groove surface formed in an S-shape. The S-shaped groove surface includes: a spiral area disposed near each of the pair of deflector openings and extending along a spiral direction in which the raceway extends, and a bent area adjacent to the spiral area and gradually deviating from the spiral direction. The tip is disposed radially outside with respect to the bent area.

Furthermore, in a preferred aspect of the above-described ball screw device, the circulation groove surface is an S-shaped groove surface formed in an S-shape. When viewed from a radial outside of the screw shaft, the recess and the deflector have a length in an intersecting direction crossing an axial direction longer than a length in the axial direction parallel to the screw shaft.

According to the above configuration, a ratio of the S-shaped groove surface in an intersecting direction increases. In other words, a degree of a curve of the S-shaped groove surface becomes gentle. Therefore, the ball smoothly moves on the S-shaped groove surface.

Furthermore, the circulation groove surface of the above-described ball screw device extends in a reverse spiral direction opposite to a spiral direction in which the raceway extends.

Furthermore, in a preferred aspect of the above-described ball screw device, the outer peripheral raceway surface has a thread height that is greater than a thread height of the inner peripheral raceway surface.

According to the above configuration, since a height of a screw thread on the outer peripheral raceway surface increases, it is difficult for the ball to ride on the groove shoulder of the outer peripheral raceway surface. Still more, according to the above configuration, a bottom of the outer peripheral raceway surface is deep. Therefore, when the ball moves from the outer peripheral raceway surface to the circulation groove surface of the deflector, the amount of step (radial movement amount) between the outer peripheral raceway surface and the circulation groove surface of the deflector is small. On the other hand, when the deflector is provided in the nut, the bottom of the inner peripheral raceway surface is shallow, so that the amount of step (radial movement amount) between the inner peripheral raceway surface and the circulation groove surface of the deflector is large.

Therefore, according to the present disclosure, the radial movement amount of the ball is suppressed, and the ball smoothly moves on the circulation groove surface.

Furthermore, in a preferred aspect of the above-described ball screw device, the circulation groove surface includes: a pair of inlet/outlet groove surfaces disposed at both ends in an extending direction of the circulation groove surface, the pair of inlet/outlet groove surfaces extending in a circumferential direction from the pair of deflector openings, and a concave surface in which the plurality of balls sinks radially inward, the concave surface being disposed between the pair of inlet/outlet groove surfaces.

According to the above configuration, when a radially outward load acts on the deflector, the ball rolling on an inlet/outlet groove surface abuts on the inner peripheral raceway surface of the nut. Therefore, a radially-outward movement of the deflector is restricted, and the deflector can be prevented from coming off the recess.

Furthermore, in a preferred aspect of the above-described ball screw device, the circulation groove surface includes a concave surface in which the plurality of balls sinks radially inward. The concave surface is linear when viewed in the axial direction.

In a conventional concave surface, when viewed in an axial direction, a concave shape is formed with a central portion in the S-shape direction more recessed radially inward than both ends in the S-shape direction in which the concave surface extends. On the other hand, since the concave surface of the above configuration is linear when viewed in the axial direction, a bending angle when the ball enters the concave surface becomes small. Therefore, rolling of the ball becomes smooth.

Furthermore, in a preferred aspect of the above-described ball screw device, the pair of deflector openings has a groove shape larger than a groove shape of the two screw shaft openings.

According to the above configuration, even when the deflector moves radially outward, an edge of the deflector opening does not move into a screw shaft opening. Therefore, the edge of the deflector opening is prevented from coming into contact with the ball.

### Advantageous Effects of Invention

According to the ball screw device of the present disclosure, smooth rolling of the ball is ensured. In addition, a breakage of the groove shoulder of the circulation groove surface is avoided.

### BRIEF DESCRIPTION OF DRAWINGS

FIG. 1 is a cross-sectional view of a brake caliper according to an embodiment.

FIG. 2 is a perspective view of a deflector and a recess of a ball screw device according to the embodiment.

FIG. 3 is an enlarged view from radially outside of the recess and the deflector according to the embodiment.

FIG. 4 is a cross-sectional view schematically illustrating a cross section taken along a center of an S-shaped groove surface.

FIG. 5 is a diagram viewed from the recess illustrating an opening (screw shaft opening) on an outer peripheral raceway surface provided on a second opposing surface of the recess.

FIG. 6 is a diagram illustrating a state in which the deflector has moved radially outward from a state in FIG. 5.

FIG. 7 is an enlarged view in which a portion at a lower left of the recess and the deflector in FIG. 3 is enlarged.

FIG. 8 is a cross-sectional view taken along line VIII-VIII in FIG. 7.

FIG. 9 is a cross-sectional view of a ball screw device of Comparative Example 1 taken along a central portion of a groove width of an S-shaped groove surface.

FIG. 10 is a diagram illustrating a deflector of Comparative Example 2 in an abstract manner.

FIG. 11 is a diagram schematically illustrating the deflector according to the exemplary embodiment in an abstract manner.

FIG. 12 is a schematic diagram illustrating a deflector according to Modification 1 as viewed from the radial outside.

FIG. 13 is a schematic cross-sectional view of a deflector according to Modification 2 taken along a circulation groove surface.

FIG. 14 is a schematic cross-sectional view of a deflector according to Modification 3 taken along a circulation groove surface.

FIG. 15 is a schematic cross-sectional view of a deflector according to Modification 4 taken along a circulation groove surface.

FIG. 16 is a schematic view of a deflector according to Modification 5 as viewed from the radial outside.

FIG. 17 is a schematic view of a deflector according to Modification 6 as viewed from the radial outside.

### DESCRIPTION OF EMBODIMENTS

Hereinafter, the present disclosure will be described in detail with reference to the drawings. Note that the present invention is not limited to the following mode (hereinafter referred to as an embodiment) for carrying out the present invention. In addition, components in the following embodiment include components that can be easily assumed by those skilled in the art, components that are substantially the same, and components within a so-called equivalent range. Furthermore, the components disclosed in the following embodiment can be appropriately combined.

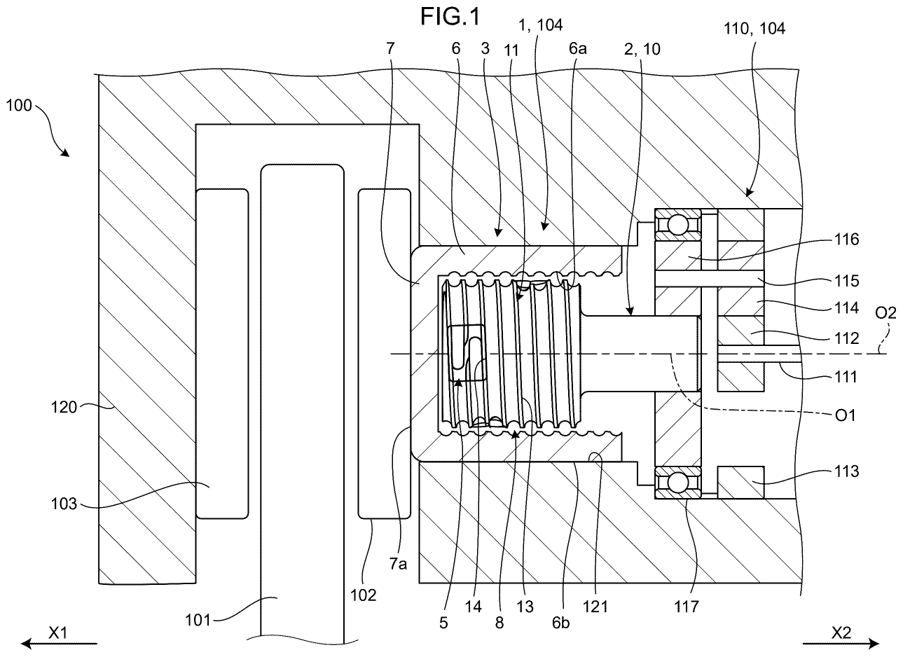

FIG. 1 is a cross-sectional view of a brake caliper according to an embodiment. As illustrated in FIG. 1, a brake caliper 100 is a device that sandwiches a wheel (not illustrated) and a brake disc 101 that follows the wheel between two brake pads 102 and 103 to suppress a rotational motion of the wheel. The brake caliper 100 includes a brake disc 101, two brake pads 102 and 103, an electric actuator 104 that operates the brake pad 102, and a housing 120.

The electric actuator 104 includes a motor (not illustrated) that generates rotational motion, a speed reducer 110 that decelerates the rotational motion, and a ball screw device 1 that converts the rotational motion into linear motion. In the following description, a direction parallel to an axis O1 of a screw shaft 2 of the ball screw device 1 is referred to as an axial direction.

In the axial direction, a direction in which the brake disc 101 is disposed, as viewed from the ball screw device 1, is referred to as a first direction X1, and a direction opposite to the first direction X1 is referred to as a second direction X2.

The speed reducer 110 is a planetary gear mechanism. The speed reducer 110 includes an input shaft 111, a sun gear 112, a ring gear 113, a plurality of planetary gears 114, a plurality of transmission shafts 115, and a carrier 116.

The rotational motion of the motor is input to the input shaft 111. The input shaft 111 extends in the axial direction. An axis O2 of the input shaft 111 is located on an extension line of the axis O1. The sun gear 112 penetrates the input shaft 111 and is non-rotatably fixed to the input shaft 111. The ring gear 113 is an internal gear centered on the axis O2. An outer peripheral surface of the ring gear 113 is fitted to the housing 120.

The planetary gear 114 is disposed between the sun gear 112 and the ring gear 113, and is engaged with the sun gear 112 and the ring gear 113. The planetary gear 114 is penetrated by the transmission shaft 115. The planetary gear 114 is rotatably supported around the transmission shaft 115.

The carrier 116 is an annular component centered on the axis O1. An outer peripheral surface of the carrier 116 is fitted to a bearing 117. Therefore, the carrier 116 is rotatably supported by the housing 120. A connecting portion 10 of the screw shaft 2 is inserted into a central portion of the carrier 116. The carrier 116 and the connecting portion 10 are spline-fitted. Therefore, the carrier 116 and the connecting portion 10 are coupled so as not to rotate relative to each other. In addition, the transmission shaft 115 penetrates a position eccentric to the radial outside from the central portion of the carrier 116.

As described above, when the rotational motion is transmitted from the motor (not illustrated) to the input shaft 111, the sun gear 112 rotates about the axis O2. The planetary gear 114 rotates (revolution) about the axis O2 while rotating (rotation) about the transmission shaft 115. As a result, the carrier 116 and the screw shaft 2 rotate about the axis O1. A rotational speed of the screw shaft 2 is decelerated more than the rotational speed of the input shaft 111.

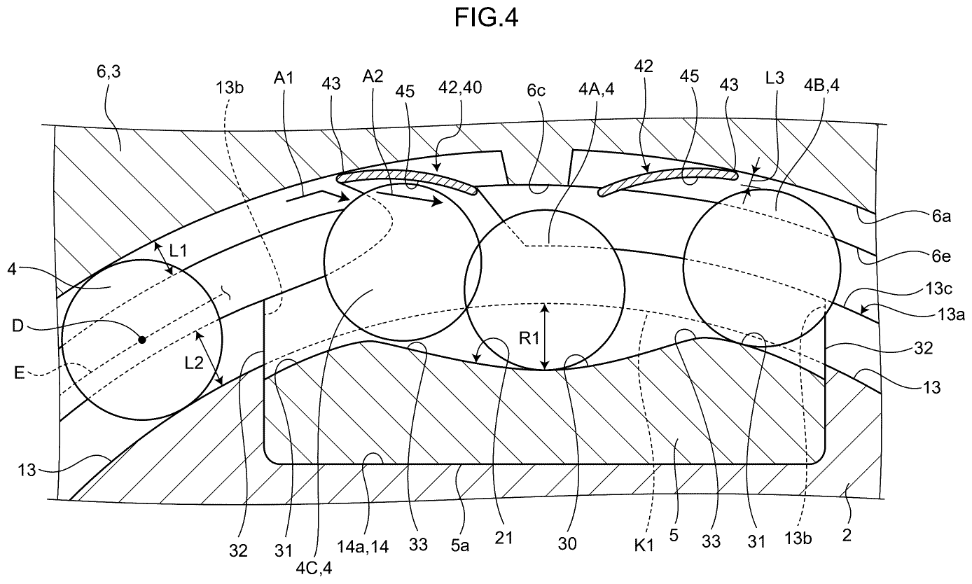

The ball screw device 1 includes the screw shaft 2, a nut 3, a ball 4 (not illustrated in FIG. 1, see FIG. 4), and a plurality of deflectors 5 (only one is illustrated in FIG. 1). The screw shaft 2 includes the connecting portion 10 connected to the carrier 116 and a screw shaft body 11 disposed in the first direction X1 with respect to the connecting portion 10 and inserted into the nut 3. An outer peripheral surface of the screw shaft body 11 is provided with an outer peripheral raceway surface 13 extending in a spiral direction and a plurality of recesses 14 (only one is illustrated in FIG. 1) recessed radially inward.

The nut 3 is formed in a bottomed cylindrical shape. Therefore, the nut 3 includes a nut body 6 having the cylindrical shape and a lid 7 that closes an opening of the nut body 6. An inner peripheral raceway surface 6a facing the outer peripheral raceway surface 13 is provided on an inner peripheral surface of the nut body 6. A raceway 8 having a spiral shape is formed between the outer peripheral raceway surface 13 and the inner peripheral raceway surface 6a. A plurality of balls 4 is arranged in the raceway 8.

An outer peripheral surface 6b of the nut body 6 abuts on a support surface 121 of the housing 120. The outer peripheral surface 6b and the support surface 121 of the nut body 6 each have a circular shape centered on the axis O1. A minute clearance is provided between the support surface 121 and the outer peripheral surface 6b of the nut body 6 so that the nut 3 is slidable. In other words, the support surface 121 supports the nut 3 in a way such that the nut 3 is slidable in the axial direction.

Further, a rotation stopper (not illustrated) is provided on the outer peripheral surface 6b of the nut body 6. The rotation stopper regulates the nut 3 so as not to rotate about the axis O1.

The lid 7 closes the opening of the nut body 6 in the first direction X1. A surface 7a of the lid 7 facing the first direction X1 is in contact with the brake pad 102.

From the above, when the nut 3 moves in the first direction X1 by the rotation of the screw shaft 2, the brake pad 102 moves in the first direction X1. The brake pad 102 presses the brake disc 101 in the first direction X1, and the brake disc 101 comes into contact with the brake pad 103. As a result, the brake disc 101 is sandwiched between the brake pads 102 and 103, and the rotation of the wheel (not illustrated) is restricted.

The deflector 5 is a circulation device that returns the ball 4, which has moved one lead in the raceway 8, by one lead. One deflector 5 is attached to one recess 14. In the present disclosure, a method of fixing the deflector 5 onto the recess 14 is not particularly limited. In other words, the deflector 5 may or may not be fixed onto the recess 14. Therefore, in the present disclosure, the deflector 5 may be loosely fitted into the recess 14.

Alternatively, a fastening allowance may be provided on the deflector 5 to fit with the recess 14. Alternatively, the deflector 5 may be bonded to the recess 14. In addition, the deflector 5 may be fixed to the recess 14 by caulking. Whether or not the deflector 5 is fixed as described above is not particularly limited.

When viewed in the axial direction, the plurality of deflectors 5 (plurality of recesses 14) is disposed in different directions from axis O1. As a result, a load acting on the screw shaft 2 from the nut 3 via the ball 4 is evenly distributed in a circumferential direction. It is more preferable that the plurality of deflectors 5 is arranged at equal intervals in the circumferential direction.

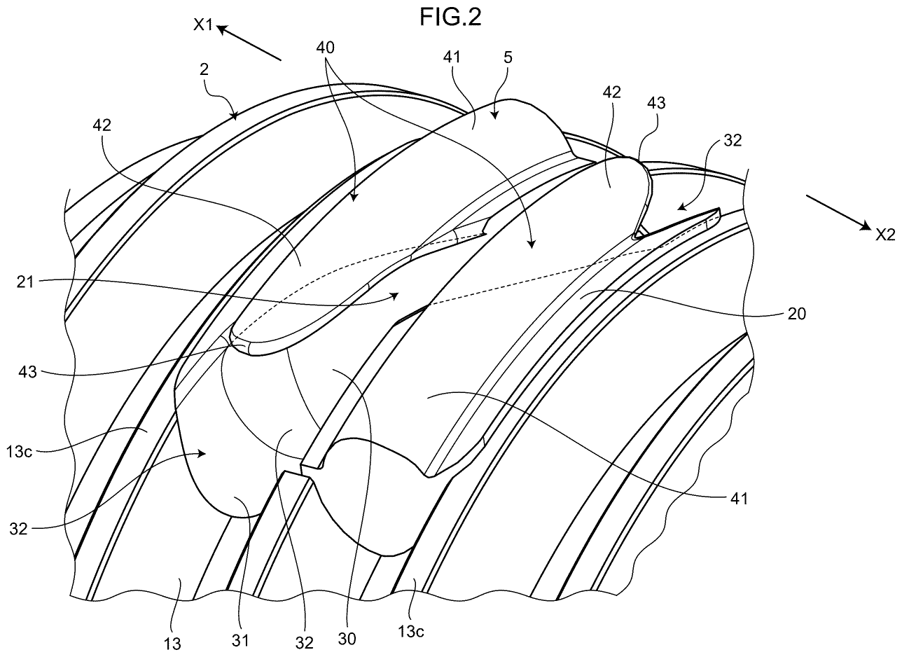

FIG. 2 is a perspective view of the deflector and the recess of the ball screw device according to the embodiment. As illustrated in FIG. 2, the deflector 5 includes an S-shaped groove surface 21, a pair of deflector openings 32 and 32 opened in the S-shaped groove surface 21, and a pair of tongues 40 and 40 protruding toward the deflector openings 32. Details of the recess 14 and the deflector 5 will be described below.

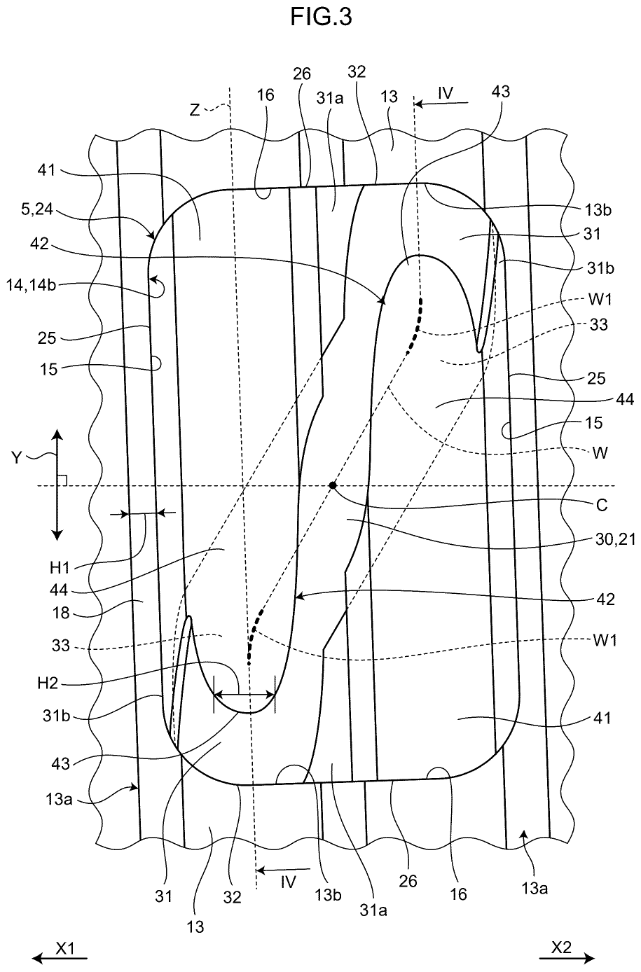

FIG. 3 is an enlarged view of the recess and the deflector according to the embodiment as viewed from a radial outside. Hereinafter, as illustrated in FIG. 3, a direction orthogonal to the axis O1 when viewed from the radial outside is referred to as an intersecting direction Y. In addition, a direction parallel to a virtual line Z extending along the raceway 8 is referred to as a spiral direction. As illustrated in FIG. 3, the recess 14 has an inner peripheral surface 14b. The inner peripheral surface 14b has a pair of first opposing surfaces 15 and 15 and a pair of second opposing surfaces 16 and 16.

The first opposing surface 15 is a surface extending in the intersecting direction Y when viewed from the radial outside. The pair of first opposing surfaces 15 and 15 faces each other in the axial direction. The first opposing surface 15 extends linearly when viewed from the radial outside.

The second opposing surface 16 is a surface extending in the axial direction. The pair of second opposing surfaces 16 and 16 faces each other in the intersecting direction Y. The pair of second opposing surfaces 16 is parallel to the axial direction (see axis O1). A length of the first opposing surface 15 from one end to the other end in the intersecting direction Y is longer than a length of the second opposing surface 16 from one end to the other end in the axial direction.

The deflector 5 is formed point-symmetrically with respect to a center C (see FIG. 3). The deflector 5 has an outer peripheral surface 24 forming an annular shape around the center C. The outer peripheral surface 24 has a pair of first side surfaces 25 and 25 facing the pair of first opposing surfaces 15 and 15, and a pair of second side surfaces 26 and 26 facing the pair of second opposing surfaces 16 and 16.

An outer shape (outer peripheral surface 24) of the deflector 5 is identical to an inner shape (inner peripheral surface 14b) of the recess 14. Therefore, the first side surface 25 linearly extends in the intersecting direction Y, similarly to the first opposing surface 15.

Similarly to the second opposing surface 16, the second side surface 26 extends linearly in the axial direction. A length from one end to the other end in the intersecting direction Y of the first side surface 25 is longer than a length from one end to the other end in the axial direction of the second side surface 26. Bottom surface 5a of the deflector 5 is in contact with a bottom surface 14a of the recess 14 (see FIG. 4). The bottom surface 5a and the bottom surface 14a are flat surfaces.

As described above, when viewed from the radial outside, the recess 14 and the deflector 5 are quadrangular. In addition, a length of the recess 14 and the deflector 5 in intersecting direction Y is longer than a length thereof in the axial direction.

To describe the shapes of the recess 14 and the deflector 5 in more detail, the first opposing surface 15 of the recess 14 is tilted with respect to the intersecting direction Y and is parallel to the spiral direction (see the virtual line Z). Similarly, the first side surface 25 of the deflector 5 is also parallel to the spiral direction. In other words, the first opposing surface 15 and the first side surface 25 are parallel to a screw thread 13a. When viewed from the radial outside, the recess 14 and the deflector 5 are parallelograms.

Still more, the screw thread 13a of the outer peripheral raceway surface 13 of the screw shaft 2 is cut out in a range overlapping with the recess 14. Therefore, a part of the screw thread 13a configures a thin portion 18 having a small thickness H. The thickness H is a thickness in an orthogonal direction orthogonal to the spiral direction.

Here, when the first opposing surface 15 extends in the intersecting direction Y, a portion having a large thickness H and a portion having a small thickness H are generated in the thin portion 18. The portion having the small thickness H has relatively a small strength, and the screw thread 13a is easily deformed. On the other hand, according to the present embodiment, the first opposing surface 15 and the first side surface 25 are parallel to the screw thread 13a. In other words, the thickness H of the thin portion 18 is uniform over the entire direction in which the thin portion 18 extends. Therefore, in the thin portion 18 of the present embodiment, there is no portion having relatively weak strength, and deformation of the screw thread 13a (thin portion 18) is suppressed. In addition, the second opposing surface 16 and the second side surface 26 of the present embodiment are tilted with respect to the axial direction and are parallel to the orthogonal direction orthogonal to the spiral direction (see virtual line Z) .

Next, the S-shaped groove surface 21 will be described. An extending direction in which the S-shaped groove surface 21 extends (direction along a virtual line W passing through the center of a groove width of the S-shaped groove surface 21 in FIG. 3) is referred to as an S-shape direction. The S-shaped groove surface 21 is a circulation groove surface whose internal space forms a circulation pathway. Therefore, when the ball 4 moves on the S-shaped groove surface 21, the ball 4 returns by one lead. Further, the S-shaped groove surface 21 is formed in an S-shape when viewed from the radial outside. In other words, the S-shaped groove surface 21 includes a central groove surface 30 disposed at a central portion of the S-shaped groove surface 21 in the S-shape direction, two inlet/outlet groove surfaces 31 disposed at both ends of the S-shaped groove surface 21 in the S-shape direction, and a bent groove surface 33 connecting the central groove surface 30 and the inlet/outlet groove surface 31. Further, the deflector opening 32 that is opened in the inlet/outlet groove surface 31 in the intersecting direction is provided on the second side surface 26 of the deflector 5.

The central groove surface 30 and the inlet/outlet groove surface 31 are formed linearly, and the balls 4 roll smoothly. Further, the inlet/outlet groove surface 31 is continuous with the outer peripheral raceway surface 13 of the screw shaft 2 via the deflector opening 32. The inlet/outlet groove surface 31 extends in the spiral direction and is parallel (linear) to the outer peripheral raceway surface 13. Therefore, the ball 4 smoothly enters the inlet/outlet groove surface 31 from the outer peripheral raceway surface 13. Since the inlet/outlet groove surface 31 extends in the spiral direction, it may be referred to as a spiral area.

The bent groove surface 33 (see virtual line W1 of the virtual line W in FIG. 3) is bent and formed in an arc shape when viewed from the radial direction. In other words, a central portion of a groove width of the bent groove surface 33 greatly deviates from the spiral direction (see virtual line Z) as approaching the central groove surface 30. Therefore, when the ball 4 rolling on the bent groove surface 33 moves, the ball 4 deviates from the spiral direction. Since the bent groove surface 33 is bent, it may be referred to as a bent area.

As described above, the deflector 5 has the length in the intersecting direction Y longer than the length in the axial direction. Therefore, a length of the central groove surface 30 in the intersecting direction Y is also relatively long. As a result, an S-shaped bending degree of the S-shaped groove surface 21 (bent groove surface 33) viewed from the radial outside (see virtual line W1 in the virtual line W in FIG. 3) is gentle (small curvature). Accordingly, the ball 4 smoothly rolls on the S-shaped groove surface 21 (bent groove surface 33).

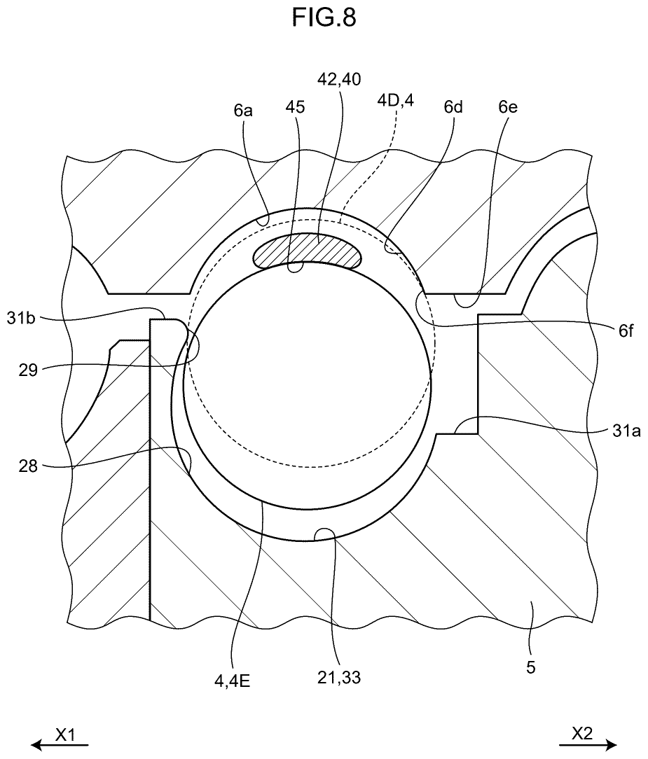

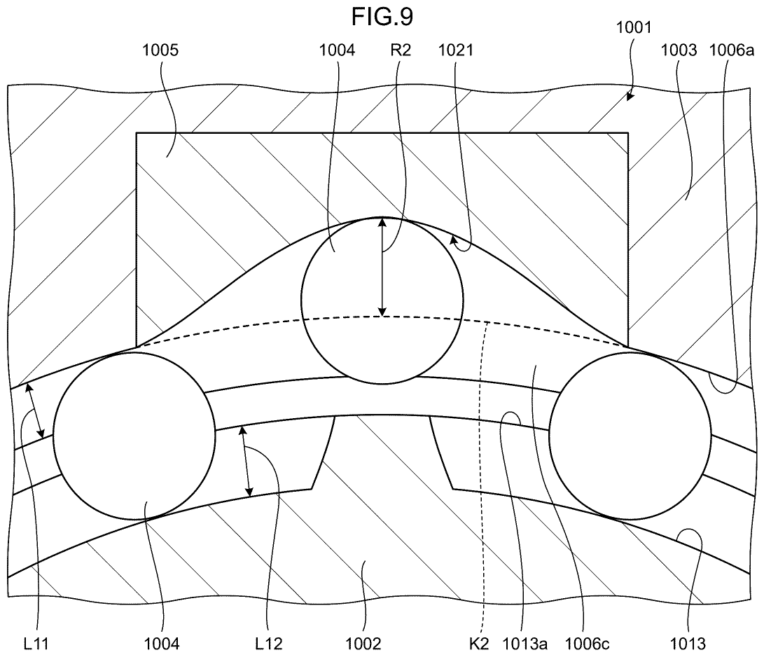

In addition, one groove shoulder 31a of the inlet/outlet groove surface 31 in the axial direction is largely cut out. The one groove shoulder 31a in the axial direction is a groove shoulder disposed in a direction in which the center C of the deflector 5 is located as viewed from the center (virtual line W) of the groove width of the inlet/outlet groove surface 31. Therefore, the one groove shoulder 31a in the axial direction is recessed radially inward, compared with the other groove shoulder 31b in the axial direction (see FIG. 8).

FIG. 4 is a cross-sectional view schematically illustrating a cross section taken along the center of the S-shaped groove surface. A virtual line Kl in FIG. 4 is a line extending the outer peripheral raceway surface 13 of the screw shaft 2 in the circumferential direction. In FIG. 4, only a part of the plurality of balls 4 is illustrated in order to make the S-shaped groove surface 21 easy to see.

As illustrated in FIG. 4, the central groove surface 30 and the bent groove surface 33 are disposed radially inward of the virtual line K1. The two bent groove surfaces 33 are tilted toward the central portion of the central groove surface 30 in the S-shape direction, so as to be gradually located radially inward. In other words, a cross-sectional shape obtained by cutting the central groove surface 30 and the bent groove surface 33 along the S-shape direction is a concave shape. Therefore, the central groove surface 30 and the bent groove surface 33 are concave surfaces, and the balls 4 rolling on the central groove surface 30 and the bent groove surface 33 sink radially inward.

To describe the movement of the ball 4 in detail, the ball 4 moves radially inward as approaching the central portion of the central groove surface 30 in the S-shape direction from one bent groove surface 33 of the two bent groove surfaces 33 (see ball 4A of the balls 4 illustrated in FIG. 4). The ball 4A moves radially outward as approaching the other bent groove surface 33 from the central portion of the central groove surface 30 in the S-shape direction. As a result, the ball 4 rides over a screw thread 6c of the inner peripheral raceway surface 6a. In the present embodiment, a movement amount R1 is a radial movement amount when the ball 4 rolls on the S-shaped groove surface 21 (the central groove surface 30 and the bent groove surface 33).

In the nut 3 of the present embodiment, a height L1 is a height of the screw thread 6c of the inner peripheral raceway surface 6a. A height L2 is a height of the screw thread 13a of the outer peripheral raceway surface 13. The height L2 of the screw thread 13a of the outer peripheral raceway surface 13 is larger than the height L1 of the screw thread 6c (L2>L1). Therefore, it is difficult for the ball 4 to ride on the groove shoulder 13c of the outer peripheral raceway surface 13. The height is a distance (depth) from the groove bottom to the groove shoulder.

As illustrated in FIG. 4, the inlet/outlet groove surface 31 extends in the circumferential direction from the deflector opening 32. In other words, the groove bottom of the inlet/outlet groove surface 31 has a constant distance from the axis O1. In other words, unlike the concave surface (central groove surface 30 and bent groove surface 33), the inlet/outlet groove surface 31 of the present embodiment is not tilted so as to be positioned radially inward toward the central portion in the S-shape direction. Therefore, even when the ball 4 rolling on the inlet/outlet groove surfaces 31 approaches the central portion of the central groove surface 30 in the S-shape direction, the ball 4 does not move radially inward (see ball 4B among the balls 4 illustrated in FIG. 4). According to the inlet/outlet groove surface 31, when a radially outward load acts on the deflector 5, the ball 4B rolling on the inlet/outlet groove surface 31 abut on the inner peripheral raceway surface 6a of the nut 3.

Therefore, the radially-outward movement of the deflector 5 is restricted, and the deflector 5 does not come off from the recess 14.

In the present embodiment, the groove bottom of the inlet/outlet groove surface 31 is disposed radially inward of the virtual line K1. Therefore, when a radially outward load acts on the deflector 5, the deflector 5 moves slightly radially outward. Then, the ball 4B rolling on the inlet/outlet groove surface 31 also moves slightly radially outward and abuts on the inner peripheral raceway surface 6a of the nut 3. Therefore, the radially-outward movement of the deflector 5 is restricted to a small movement amount, and the deflector 5 does not come off from the recess 14.

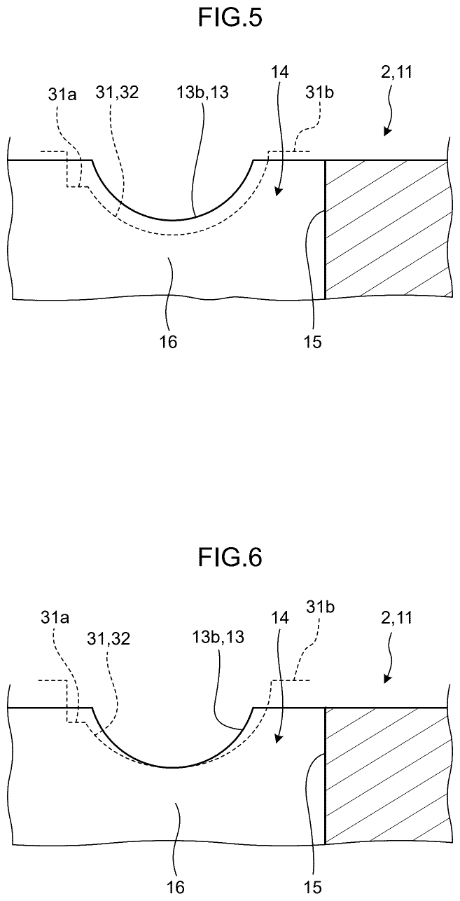

FIG. 5 is a diagram, viewed from the recess, illustrating an opening (screw shaft opening) in the outer peripheral raceway surface provided on the second opposing surface of the recess. As illustrated in FIG. 5, a screw shaft opening 13b of the outer peripheral raceway surface 13 is provided in the second opposing surface 16 of the inner peripheral surface 14b of the recess 14. Screw shaft opening 13b is adjacent to the deflector opening 32 (see FIGS. 2 to 4) of the deflector 5 in the rolling direction (S-shape direction) of ball 4.

As illustrated in FIG. 5, when viewed in the rolling direction of the ball 4, a groove shape of the inlet/outlet groove surface 31 of the S-shaped groove surface 21 is larger than a groove shape of the outer peripheral raceway surface 13. In other words, when viewed in the rolling direction of the ball 4, a groove shape of the deflector opening 32 is also larger than a groove shape of the screw shaft opening 13b. In other words, the screw shaft opening 13b is disposed inside the deflector opening 32. Therefore, the deflector opening 32 is deeper than the screw shaft opening 13b and has a larger groove width.

For this reason, as illustrated in FIG. 4, the inlet/outlet groove surface 31 is disposed radially inward of the virtual line K1 (outer peripheral raceway surface 13). Since the inlet/outlet groove surface 31 is disposed radially inward of the virtual line K1, the load from the nut 3 acting on the inlet/outlet groove surface 31 via the ball 4 is reduced, and deformation of the deflector 5 is suppressed.

FIG. 6 is a diagram illustrating a state in which the deflector has moved radially outward from the state in FIG. 5. Further, as illustrated in FIG. 6, since the groove shape of the deflector opening 32 is larger than the groove shape of the screw shaft opening 13b, the deflector opening 32 does not move inward of the screw shaft opening 13b even when the deflector 5 is displaced radially outward. In other words, the ball 4 moving from the outer peripheral raceway surface 13 to the inlet/outlet groove surface 31 is prevented from being caught by an edge of the deflector opening 32.

Next, details of the tongue 40 will be described. As illustrated in FIG. 2, the deflector 5 has an outer diameter surface 20 facing radially outward. The outer diameter surface 20 is disposed radially outside the groove shoulder 13c of the outer peripheral raceway surface 13. The tongue 40 includes a base 41 having a semicircular columnar shape further protruding radially outward from the outer diameter surface 20, and a tongue body 42 protruding from the base 41 toward the deflector opening 32. Further, two tongues 40 are axially spaced apart from each other.

The screw thread 6c of the nut 3 is disposed between the two tongues 40.

As shown in FIG. 3, the tongue 40 extends in the spiral direction. Although not particularly illustrated, the tongue 40 is accommodated inside the inner peripheral raceway surface 6a of the nut 3. In addition, the tongue 40 is separated from the inner peripheral raceway surface 6a of the nut 3 and is not in contact with the inner peripheral raceway surface 6a.

A central portion of the tongue body 42 in a width direction (orthogonal direction) overlaps with the virtual line Z. A length H2 of the tongue body 42 in the width direction (orthogonal direction) decreases toward the deflector opening 32, and has a tapered shape. A tip 43 of the tongue body 42 is disposed radially outside the inlet/outlet groove surface 31 (specifically, disposed radially outside a portion of the inlet/outlet groove surface 31 closer to the bent groove surface 33). The central portion of the tongue body 42 in the spiral direction is disposed radially outside the bent groove surface 33. In addition, the base 44 of the tongue body 42 is disposed radially outside the central groove surface 30 (specifically, disposed radially outside a portion of the central groove surface 30 closer to the bent groove surface 33).

As illustrated in FIG. 4, the tip 43 of the tongue body 42 is disposed radially outside the groove shoulder 6e of the inner peripheral raceway surface 6a. Therefore, a step L3 between the groove bottom of the inner peripheral raceway surface 6a and the tip 43 is small. Still more, the tongue body 42 has an inner diameter surface 45 facing radially inward. The inner diameter surface 45 is tilted so as to be positioned radially inward from the tip 43 toward the base 44.

According to the tongue 40 described above, the ball 4 entering the S-shaped groove surface 21 from the deflector opening 32 comes into contact with the tip 43 of the tongue body 42 on the inlet/outlet groove surface 31.

As a result, the ball 4 that has moved in the spiral direction changes its direction to a radially inner side (see arrow Al in FIG. 4). The ball 4 then moves radially inward of the tongue body 42. Therefore, the ball 4 travels radially inward compared with when the tongue 40 is not provided. In addition, since the step L3 of the tip 43 is small, the ball 4 smoothly moves without being caught at contacting the tip 43.

The ball 4 moving radially inward of the tongue body 42 is guided by the inner diameter surface 45 and gradually positioned on the radially inner side. Therefore, the ball 4 moves along the concave surface (the central groove surface 30 and the bent groove surface 33). As a result, contact between the ball 4 and the screw thread 6c of the inner peripheral raceway surface 6a is reliably avoided.

Next, effects of the ball screw device 1 according to the embodiment will be described. Effects of the ball screw device 1 include a first effect, a second effect, and a third effect. The second effect and the third effect will be described using comparative examples.

The first effect is exhibited when the ball 4 changes the travel pathway on the S-shaped groove surface 21. In the present description, a case where the ball 4 enters the deflector opening 32 from the screw shaft opening 13b disposed at the lower left in FIG. 3 will be described as an example.

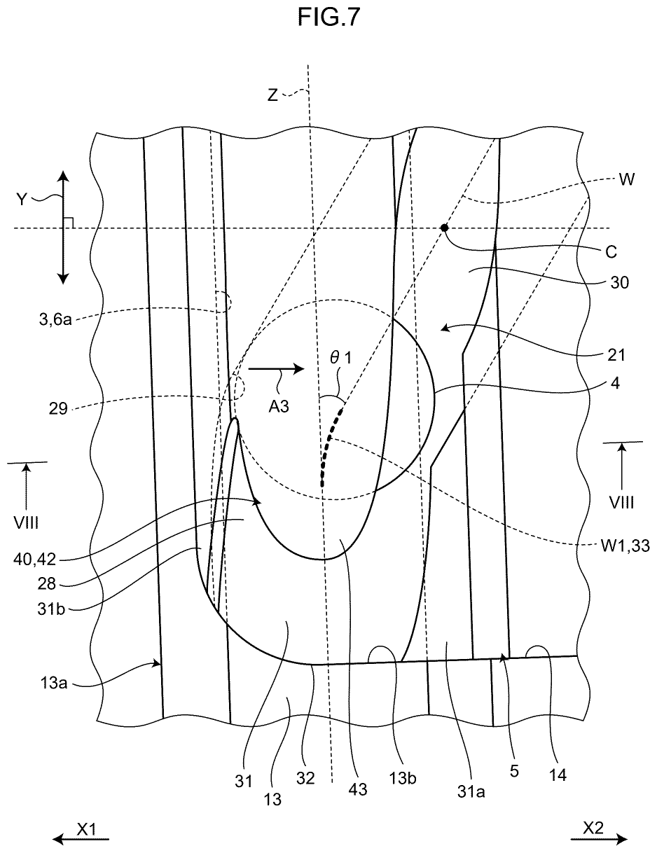

FIG. 7 is an enlarged view in which a portion at a lower left of the recess and the deflector in FIG. 3 is enlarged. FIG. 8 is a cross-sectional view taken along line VIII-VIII in FIG. 7. As illustrated in FIG. 7, the ball 4 having entered the S-shaped groove surface 21 from the deflector opening 32 moves in the spiral direction (virtual line Z) along the inlet/outlet groove surface 31. Then, the ball 4 starts to turn to the second direction X2 from the virtual line Z on the bent groove surface 33 (see W1 in the virtual line W in FIG. 7). Then, the ball 4 moves on the central groove surface 30 in a direction tilted by θ1° to the second direction X2 with reference to the spiral direction.

As described above, when rolling on the bent groove surface 33 and the central groove surface 30, the ball 4 receives a pressing load in the second direction X2 (see arrow A3 in FIG. 7). A portion of the S-shaped groove surface 21 that presses the ball 4 in the second direction X2 is a one-side groove surface (hereinafter referred to as “guide surface 28”) disposed in the first direction X1 with respect to the virtual line W.

At both ends of the bent groove surface 33 and the central groove surface 30 in the S-shape direction, an amount of recess in the radially inward direction is small (see FIG. 4). When the tongue 40 is not provided, as in a ball 4D illustrated in FIG. 8, a part of the ball 4D is disposed inside the inner peripheral raceway surface 6a of the nut 3 and abuts on the inner peripheral raceway surface 6a. A portion of the inner peripheral raceway surface 6a in contact with the ball 4D is a one-side groove surface (hereinafter referred to as an opposing surface 6d.) located in the second direction X2 with respect to the central portion of the groove width of the inner peripheral raceway surface 6a.

Therefore, the ball 4D is likely to be caught between a portion of the guide surface 28 close to the groove shoulder 31b of the S-shaped groove surface 21 (hereinafter referred to as a “guide contact portion 29”) and a portion of the opposing surface 6d (opposing contact portion 6f) close to the groove shoulder 6e. In other words, there is a high possibility that the rolling of the ball 4 is hindered, or the groove shoulder 31b or the groove shoulder be is damaged.

On the other hand, according to the present embodiment, similar to a ball 4E illustrated in FIG. 8, the ball 4E comes into contact with the tip 43 of the tongue body 42, and the ball 4E travels radially inward. Therefore, the ball 4E does not abut on the opposing surface 6d (opposing contact portion 6f), and it is avoided that the ball 4E is caught between the guide contact portion 29 and the opposing contact portion 6f. As described above, according to the embodiment, the first effect is exhibited to ensure smooth rolling of the ball 4 and also avoid a breakage of the groove shoulder 31b.

The second effect is related to the fact that the deflector 5 is provided on the screw shaft 2. Therefore, in Comparative Example 1, the deflector 5 is provided in the nut 3.

FIG. 9 is a cross-sectional view taken along a central portion of a groove width of a S-shaped groove surface of a ball screw device according to Comparative Example 1. As illustrated in FIG. 9, a ball screw device 1001 of Comparative Example 1 includes a screw shaft 1002 and a nut 1003. The ball screw device 1001 is different from the embodiment in that a deflector 1005 is provided on the nut 1003.

In addition, a height L11 of a screw thread 1006c of an inner peripheral raceway surface 1006a of the nut 1003 is the same as L1 in the embodiment. A height L12 of a screw thread 1013a of an outer peripheral raceway surface 1013 of the screw shaft 1002 is the same as L2 in the embodiment. A virtual line K2 in FIG. 9 is a line extending the inner peripheral raceway surface 1006a in the circumferential direction.

When a ball 1004 moves on an S-shaped groove surface 1021 of the deflector 1005, a movement amount R2 is radial movement amount of the ball 1004. The movement amount R2 in the radial direction is a movement amount for the ball 1004 to exceed the height amount L12 of the screw thread 1013a of the outer peripheral raceway surface 1013 in order to avoid contact with the screw thread 1013a. In the inner peripheral raceway surface 1006a of Comparative Example 1, the screw thread 1006c has the height L11, which is small. Therefore, a bottom of the inner peripheral raceway surface 1006a is shallow, and an amount of step between the bottom of the inner peripheral raceway surface 1006a and the deepest portion of the S-shaped groove surface 1021 is large. In other words, according to Comparative Example 1, the movement amount R2 by which the ball 1004 moves in the radial direction is large.

On the other hand, as illustrated in FIG. 4, on the outer peripheral raceway surface 13 according to the embodiment, the height L2 of the screw thread 13a is large. Therefore, the bottom of the outer peripheral raceway surface 13 is deep, and the step between the bottom of the outer peripheral raceway surface 13 and the deepest portion of the S-shaped groove surface 21 is small. In other words, according to the embodiment, the movement amount R1 by which the ball 4 moves in the radial direction is smaller than the movement amount R2 of Comparative Example 1.

As described above, the amount of step (radial movement amount) of the S-shaped groove surface 1021 of Comparative Example 1 is large. On the other hand, the amount of step of the S-shaped groove surface 21 of the embodiment is small. Therefore, according to the embodiment, the inclination of the S-shaped groove surface 21 in the depth direction (radial direction) becomes gentle, and flatness is secured. In other words, the embodiment exhibits the second effect that the ball 4 rolling on the S-shaped groove surface 21 moves smoothly.

The third effect is related to the fact that the length of the deflector 5 (recess 14) in the intersecting direction Y is longer than the axial length. Therefore, in Comparative Example 2, a circular deflector having equal length in the intersecting direction Y and the axial direction is provided.

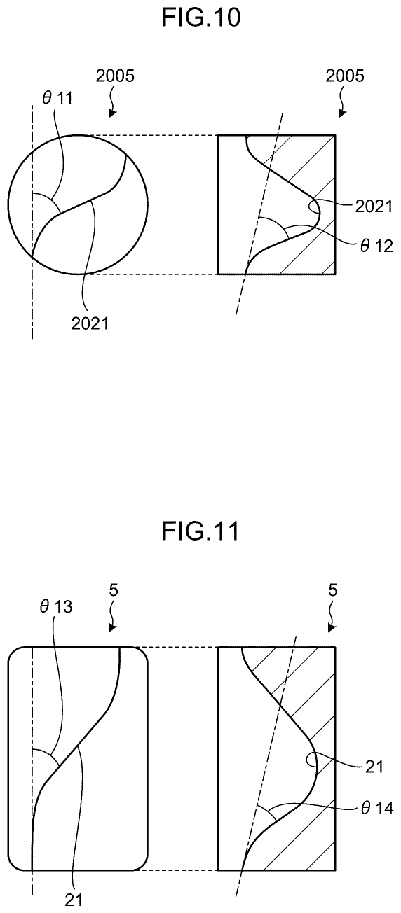

FIG. 10 is a diagram illustrating a deflector according to Comparative Example 2 in an abstract manner. FIG. 11 is a diagram illustrating the deflector according to the embodiment in an abstract manner; As illustrated in FIG. 10, deflector 2005 of Comparative Example 2 has a circular outer shape. According to the deflector 2005 of Comparative Example 2, an angle θ11 at which the ball turns to the axial direction along a S-shaped groove surface 2021 is relatively large. Further, according to the deflector 2005 of Comparative Example 2, an angle θ12 at which the ball turns to the radial direction along the S-shaped groove surface 2021 is relatively large.

As illustrated in FIG. 11, the deflector 5 according to the embodiment is longer in the intersecting direction than in the axial direction. Therefore, an angle θ13 at which the ball turns to the axial direction along the S-shaped groove surface 21 is small, and the inclination is gentler than that of Comparative Example 2. In addition, an angle θ14 at which the ball turns to the radial direction along the S-shaped groove surface 21 is also small, and the inclination is gentler than that of Comparative Example 2. Therefore, according to the embodiment, the third effect is exhibited, and the ball 4 more smoothly rolls on the S-shaped groove surface 21.

In addition, according to the deflector 2005 of Comparative Example 2 illustrated in FIG. 10, it is necessary to rotate the deflector after assembling the deflector to the recess in order to make the S-shaped groove surface 2021 and an outer peripheral raceway surface (not illustrated) continuous. On the other hand, the recess 14 and the deflector 5 according to the embodiment are parallelograms (quadrangles) when viewed from the radial outside. In other words, the recess 14 and the deflector 5 are non-circular. Therefore, the S-shaped groove surface 21 and the outer peripheral raceway surface 13 become continuous only by inserting the deflector 5 into the recess 14. Therefore, a work of setting the orientation of the deflector 5 by rotating the deflector 5 after the deflector 5 is assembled to the recess 14 becomes unnecessary.

As described above, the ball screw device 1 according to the embodiment includes the nut 3 provided with the inner peripheral raceway surface 6a on the inner peripheral surface, the screw shaft 2 inserted into the nut 3 and provided with the outer peripheral raceway surface 13 on the outer peripheral surface, the plurality of balls 4 arranged on the raceway 8 between the outer peripheral raceway surface 13 and the inner peripheral raceway surface 6a, and at least one deflector 5 that circulates the balls 4. At least one recess 14 that is recessed radially inward and accommodates the deflector 5 is provided on the outer peripheral surface of the screw shaft 2. On the inner peripheral surface 14b of the recess 14, two screw shaft openings 13b of the outer peripheral raceway surface 13 opened toward the deflector 5 are provided. The deflector 5 includes a pair of deflector openings 32 and 32 opened in the outer peripheral surface 24 of the deflector 5 and connected to the screw shaft openings 13b, the circulation groove surface (S-shaped groove surface 21) connected to each of the pair of deflector openings 32 and 32 and having an internal space forming a circulation pathway, and a pair of tongues 40 and 40 disposed radially outside the circulation groove surface (S-shaped groove surface 21) and protruding toward the deflector openings 32. The tip 43 of the tongue 40 is disposed radially outward of a virtual spiral E (see FIG. 4) connecting the centers of the plurality of balls 4 rolling in the raceway 8.

According to the ball screw device 1 described above, the ball 4 is prevented from being caught between the circulation groove surface (S-shaped groove surface 21) and the inner peripheral raceway surface 6a. Therefore, smooth rolling of the ball 4 and prevention of a breakage of the deflector 5 can be achieved.

Still more, the tongue 40 according to the embodiment has the inner diameter surface 45 facing radially inward. The inner diameter surface 45 is tilted so as to be gradually positioned radially inward away from the tip 43.

Accordingly, the ball 4 smoothly moves radially inward.

The tip 43 according to the embodiment is disposed on the inner peripheral raceway surface 6a of the nut 3.

According to this arrangement, when the ball 4 moves radially inward of the tongue body 42 from the inlet/outlet groove surface 31, the ball 4 smoothly rolls without being caught by the tip 43.

The circulation groove surface according to the embodiment is the S-shaped groove surface 21 formed in the S-shape. The S-shaped groove surface 21 has the spiral area disposed near the deflector opening 32 and extending along the spiral direction in which raceway 8 extends, and a bent area adjacent to the spiral area and gradually deviating from the spiral direction. The tip 43 is disposed radially outward with respect to the spiral area.

The circulation groove surface according to the embodiment is the S-shaped groove surface 21 formed in the S-shape. When viewed from the radial outside of the screw shaft 2, the length of the recess 14 and the deflector 5 in the intersecting direction Y crossing the axial direction is longer than the length in the axial direction parallel to the screw shaft 2.

According to this shape, a ratio of the S-shaped groove surface 21 in the intersecting direction Y increases, and the movement of the ball 4 on the S-shaped groove surface 21 becomes smooth.

Still more, according to the embodiment, the height L2 of the screw thread 13a on the outer peripheral raceway surface 13 is larger than the height L1 of the screw thread 6c on the inner peripheral raceway surface 6a.

Accordingly, it is difficult for the ball 4 to ride on the groove shoulder 13c of the outer peripheral raceway surface 13. Still more, the inclination of the S-shaped groove surface 21 in the radial direction becomes gentle, and the movement of the ball 4 on the S-shaped groove surface 21 becomes smooth.

Further, the circulation groove surface (S-shaped groove surface 21) according to the embodiment has a pair of inlet/outlet groove surfaces 31 and 31 that are disposed at both ends in the extending direction of the circulation groove surface (S-shaped groove surface 21) and are extending in the circumferential direction from the deflector opening 32, and a concave surface (central groove surface 30 and bent groove surface 33), where the ball 4 sinks radially inward, disposed between the pair of inlet/outlet groove surfaces 31 and 31.

According to the embodiment, even when a radially outward load acts on the deflector 5, the ball 4 rolling on the inlet/outlet groove surface 31 comes into contact with the inner peripheral raceway surface 6a. Therefore, the radially-outward movement of the deflector 5 is restricted, and the deflector 5 does not come off from the recess 14.

Still more, according to the embodiment, the deflector opening 32 of the S-shaped groove surface 21 is provided on the outer peripheral surface 24 of the deflector 5. On the inner peripheral surface 14b of the recess 14, the screw shaft opening 13b of the outer peripheral raceway surface 13 continuing to the deflector opening 32 is provided. A groove shape of the deflector opening 32 is larger than a groove shape of the screw shaft opening 13b.

Even when the deflector 5 moves radially outward, the edge of deflector opening 32 does not enter inside the screw shaft opening 13b. Therefore, the edge of the deflector opening 32 does not contact the ball 4.

Although the ball screw device according to the embodiment has been described above, the present disclosure is not limited to the ball screw device exemplified in the embodiment. For example, the ball screw device of the present disclosure may be applied to a device other than the electric actuator 104 and the brake caliper 100.

Furthermore, in the embodiment, the inner peripheral surface 14b of the recess 14 and the outer peripheral surface 24 of the deflector 5 are parallelograms, but the present disclosure may have a shape other than the parallelogram. Accordingly, in the present disclosure, the inner peripheral surface 14b of the recess 14 and the outer peripheral surface 24 of the deflector 5 may have, for example, a quadrangular shape or an elliptical shape. Still more, the pair of first opposing surfaces 15 and 15 and the pair of first side surfaces 25 and 25 extend in the spiral direction, but may extend in the intersecting direction Y. Still more, the second opposing surface 16 and the second side surface 26 extend in the direction orthogonal to the spiral direction (see virtual line Z), but may extend in the axial direction.

Still more, when the recess 14 and the deflector 5 have the quadrangular shape, a rectangle, a square, a parallelogram, a rhombus, and a trapezoid are included. Still more, a corner of the quadrangular shape may be curved, and is not particularly limited.

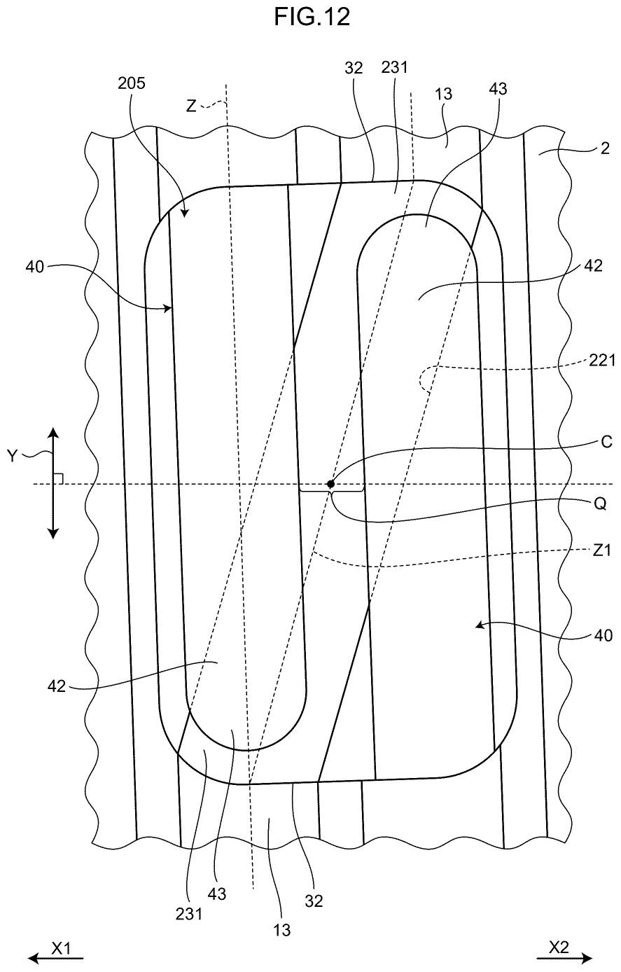

Still more, the S-shaped groove surface 21 is exemplified as the circulation groove surface of the embodiment, but the present disclosure is not limited to this shape. FIG. 12 is a schematic view of a deflector according to Modification 1 as viewed from the radial outside. In the present disclosure, as in a deflector 205 of Modification 1 illustrated in FIG. 12, a circulation groove surface 221 may extend in a reverse spiral direction Z1 direction opposite to the spiral direction Z. According to Modification 1, an inlet/outlet groove surface 231 of the circulation groove surface 221 also extends in the reverse spiral direction Z1.

In the S-shaped groove surface 21 of the embodiment, the central groove surface 30 and the inlet/outlet groove surface 31 are linear, but a curved portion may be partially provided. Still more, according to the exemplary embodiment, the central portion of the groove width of the deflector opening 32 (see virtual line W in FIG. 3) and the central portion of the groove width of the outer peripheral raceway surface 13 are disposed so as to coincide with each other in the spiral direction.

However, in the present disclosure, the central portion of the groove width of the deflector opening 32 and the central portion of the groove width of the outer peripheral raceway surface 13 may not coincide with each other in the spiral direction (may be deviated in the axial direction). Still more, although the inlet/outlet groove surface 31 of the embodiment extends in the spiral direction, the inlet/outlet groove surface of the present disclosure may not extend in the spiral direction. In other words, the inlet/outlet groove surface may extend in the intersecting direction Y or may extend in the reverse spiral direction Z1 (see inlet/outlet groove surface 231 in FIG. 12).

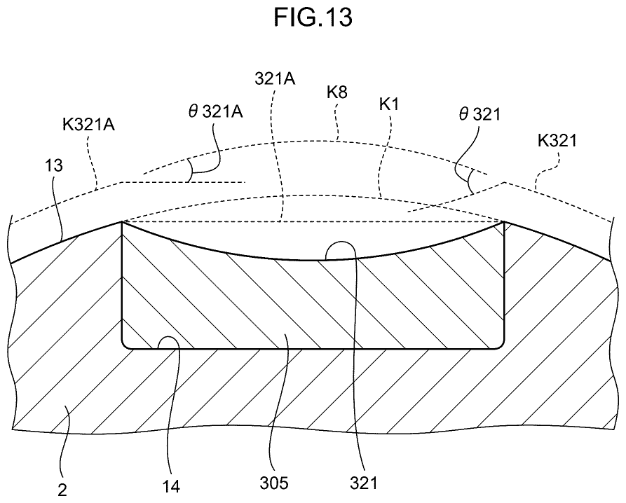

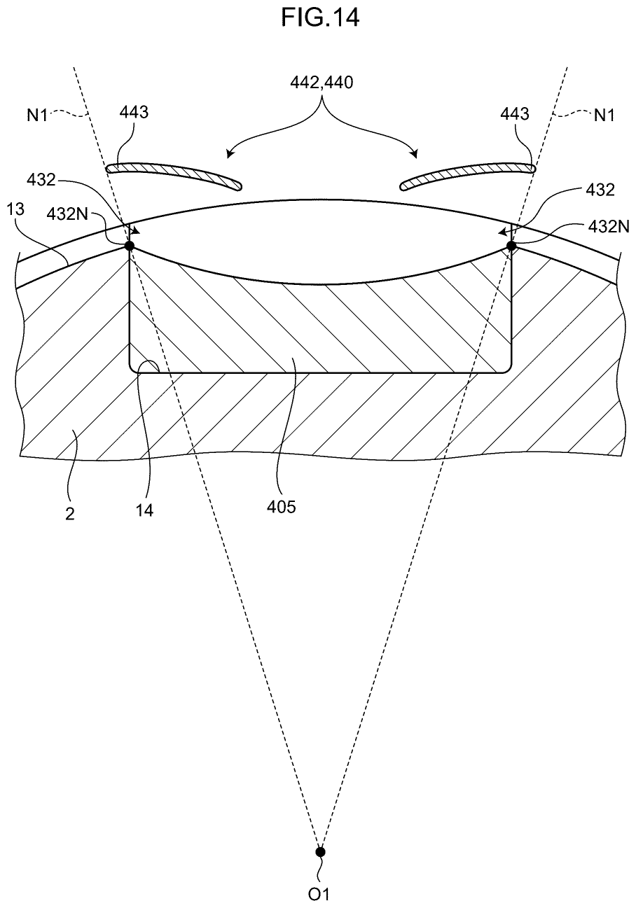

Still more, the S-shaped groove surface (circulation groove surface) 21 of the embodiment has the inlet/outlet groove surface 31 whose distance from the axis 01 is constant, but the circulation groove surface of the present disclosure may not have the inlet/outlet groove surface 31. FIG. 13 is a schematic cross-sectional view of a deflector according to Modification 2 taken along a circulation groove surface. In the present disclosure, as in a deflector 305 according to Modification 2 illustrated in FIG. 13, a circulation groove surface 321 may only have a concaved surface in which the ball 4 sinks radially inward.

Note that the concave surface in the present disclosure includes a concave surface 321A (see virtual line in FIG. 13) that is flat (linear) when viewed in the axial direction, in addition to the concave surface recessed toward the axis O1 as illustrated in Modification 2. The concave surface 321A having a planar shape is also disposed radially inward of the virtual line K1 (extension line of the outer peripheral raceway surface 13). In other words, the ball 4 can ride over the screw thread 6c (see FIG. 4) of the nut 3. A virtual line K321 illustrated in FIG. 13 is a trajectory of the center of the ball 4 rolling on the outer peripheral raceway surface 13 and the circulation groove surface 321. A virtual line K321A illustrated in FIG. 13 is a trajectory of the center of the ball 4 rolling on the outer peripheral raceway surface 13 and the concave surface 321A. A virtual line K8 illustrated in FIG. 13 is a line obtained by extending the trajectory of the center of the ball 4 rolling on the outer peripheral raceway surface 13 (raceway 8). As illustrated in FIG. 13, a bending angle θ321A when entering the concave surface 321A from the outer peripheral raceway surface 13 is smaller than a bending angle θ321 when entering the circulation groove surface 321 from the outer peripheral raceway surface 13. Therefore, the ball 4 can roll (enter) smoothly on the concave surface 321A.

Still more, in the present disclosure, the height L1 of the screw thread 6c of the inner peripheral raceway surface 6a may be the same as or larger than the height L2 of the screw thread 13a of the outer peripheral raceway surface 13. Still more, the deflector 5 of the exemplary embodiment is longer in the intersecting direction Y than in the axial direction. However, the deflector 5 of the present disclosure may be longer in the axial direction.

Still more, in the present disclosure, a material and a manufacturing method of the deflector are not particularly limited. For example, the deflector may be manufactured from a resin material such as nylon 66 resin. Still more, the deflector may be manufactured by a metal powder injection molding method. Still more, the deflector of the present embodiment is formed of one component, but may be formed of two or more components. When the deflector includes two or more components, a division plane thereof is not particularly limited. The deflector may be divided into two to the inner peripheral side and the outer peripheral side, or may be divided into two in the first direction X1 and the second direction X2.

Still more, with respect to the radial position of the tip 43 of the tongue 40, the tip 43 of the embodiment is disposed on the inner peripheral raceway surface 6a of the nut 3, but the present disclosure is not limited thereto as long as the ball 4 can be guided radially inward. In other words, it is sufficient that the tip 43 is disposed radially outside the virtual spiral E (see FIG. 4) connecting the centers D of the balls 4 rolling on the raceway 8. When the tip 43 is disposed radially outside the virtual spiral E, the tip 43 contacts the ball 4 at a position radially outside of the center D. This is because the travel pathway of the ball 4 can be changed radially inward.

Still more, the two tongues 40 are separated from each other in the present disclosure, but a distance Q (see FIG. 12) between the tongue bodies 42 may be smaller than the diameter of the ball 4. This prevents the ball 4 from falling (being caught) in a gap between the tongue bodies 42. In other words, the ball 4 smoothly moves from the inner diameter surface 45 of one tongue body 42 to the inner diameter surface 45 of the other tongue body 42.

Still more, with respect to the position of the tip 43 of the tongue body 42, the tip 43 is disposed radially outside the spiral area (inlet/outlet groove surface 31) in the present embodiment, but the present disclosure is not limited thereto. The position where the ball 4 is caught in the S-shaped groove surface 21 is not constant. Therefore, the tip 43 of the present disclosure may be disposed closer to the deflector opening 32 than a predetermined position at which ball 4 is caught in the S-shaped groove surface 21. In other words, the present disclosure is not particularly limited, and the tip 43 of the tongue 40 may be disposed radially outside with respect to the bent area (bent groove surface 33), or may be disposed at the end of the central groove surface 30 in the S-shape direction. Hereinafter, modifications will be described.

FIG. 14 is a schematic cross-sectional view of a deflector according to Modification 3 taken along a circulation groove surface. A deflector 405 according to Modification 3 includes a pair of tongues 440. A tip 443 of a tongue body 442 of the tongue 440 is in contact with a virtual line N1. The virtual line N1 is a straight line passing through the axis O1 of the screw shaft 2 and a groove bottom 432N of a deflector opening 432. According to this tongue 440, the ball 4 that has entered the deflector opening 432 is immediately guided radially inward. Therefore, the possibility that the ball 4 is caught is extremely small. In addition, when the tip 443 exceeds the virtual line N1, the ball 4 is inhibited from contacting the inner peripheral raceway surface 6a, and a load capacity of the ball screw device decreases.

Therefore, according to Modification 3, there is no possibility that the load capacity of the ball screw device becomes small. As described above, in the present disclosure, it is desirable that the tip 443 does not exceed the virtual line N1.

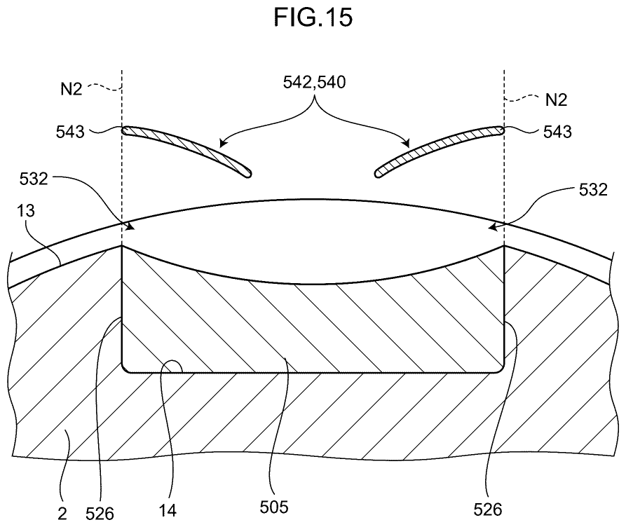

FIG. 15 is a schematic cross-sectional view of a deflector according to Modification 4 taken along a circulation groove surface. A deflector 505 according to Modification 4 includes a pair of tongues 540. A tip 543 of a tongue body 542 of the tongue 540 is in contact with a virtual line N2. The virtual line N2 extends linearly along a second side surface 526 of the deflector 505. Even in the tongue 540 according to Modification 4, a position of the tip 543 is closer to the deflector opening 532 than in the embodiment. Therefore, the possibility that the ball 4 is caught is small.

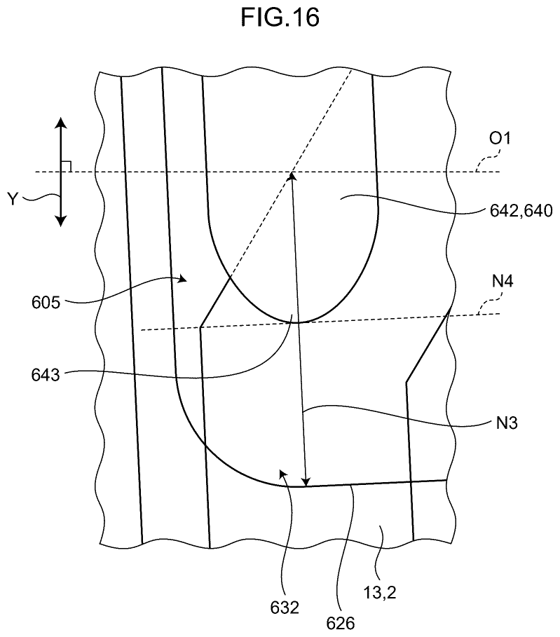

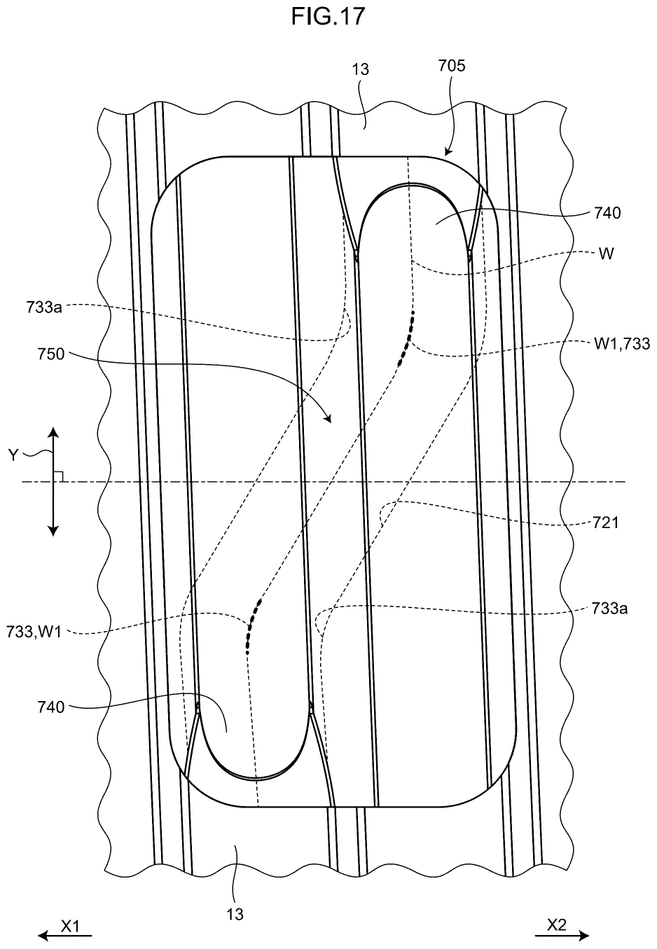

FIG. 16 is a schematic view of a deflector according to Modification 5 as viewed from the radial outside. As illustrated in FIG. 16, a deflector 605 of Modification 5 includes a pair of tongues 640 (only one is illustrated). When viewed from the radial outside, the deflector 605 has a length N3 in the circumferential direction (spiral direction) from the axis O1 to a second side surface 626. A virtual line N4 illustrated in FIG. 16 extends linearly in the axial direction, and is disposed at a position where a distance from the axis θ1 in the circumferential direction (spiral direction) is a half of the N3. In Modification 5, a tip 643 of a tongue body 642 is in contact with the virtual line N3 when viewed from the radial outside. Therefore, the tip 643 of Modification 5 is farther from the deflector opening 632 than the tip 443 of Modification 3 and the tip 543 of Modification 4, and the present disclosure may have a tongue similar to the tongue 640.

Although Modification 3 to Modification 5 have been described above, in the present disclosure, the tip of the tongue may be disposed between the virtual line N1 (see FIG. 14) and the virtual line N2 (see FIG. 15), or may be disposed between the virtual line N2 (see FIG. 15) and the virtual line N4 (see FIG. 16). Even with the above tongue, smooth rolling of the ball can be secured, and a breakage of the groove shoulder of the circulation groove surface can be avoided.

Still more, according to the embodiment, the pair of tongues 40 and 40 is disposed to be spaced apart from each other in the axial direction (See FIGS. 2, 3, etc.).

In other words, a space is provided between the pair of tongues 40 and 40, but the pair of tongues 40 and 40 may be connected to each other in the present disclosure. FIG. 17 is a schematic view of a deflector according to Modification 6 as viewed from the radial outside. More specifically, as illustrated in FIG. 17, the present disclosure may have a deflector 705 having a wall 750 that connects a pair of tongues 740 and 740. According to the deflector 705 of Modification 6, it is avoided that the ball 4 falls (moves radially outward) from between the pair of tongues 740 and 740. Therefore, it is avoided that the ball 4 comes into contact with the groove shoulder 6e (see FIG. 8) of the nut 3.

Still more, as illustrated in FIG. 17, in the present disclosure, in a bent groove surface 733 (bent area W1) of the S-shaped groove surface 721, an inner peripheral side surface 733a disposed on the inner peripheral side may have an arc shape (R shape) when viewed from the radial outside. Accordingly, the ball 4 is less likely to be caught by the inner peripheral side surface 733a, and smooth rolling of the ball 4 is secured.

Note that the present disclosure may be a combination of the following configurations.

(1)

A ball screw device includes:
a nut that has an inner peripheral raceway surface on an inner peripheral surface,
a screw shaft that is inserted into the nut and has an outer peripheral raceway surface on an outer peripheral surface,
a plurality of balls disposed on a raceway between the outer peripheral raceway surface and the inner peripheral raceway surface, and
at least one deflector that circulates the plurality of balls.

The outer peripheral surface of the screw shaft is provided with at least one recess that is recessed radially inward and accommodates the deflector.

The recess has an inner peripheral surface provided with two screw shaft openings in the outer peripheral raceway surface, and the two screw shaft openings are opened toward the deflector.

The deflector includes:
a pair of deflector openings opened in an outer peripheral surface of the deflector and connected to the two screw shaft openings,
a circulation groove surface that is connected to each of the pair of deflector openings and has an internal space forming a circulation pathway, and
a pair of tongues disposed radially outside the circulation groove surface and protruding toward the pair of deflector openings.

The pair of tongues each has a tip disposed radially outside a virtual spiral connecting centers of the plurality of balls rolling on the raceway.

(2)

The ball screw device according to (1) in which
the tongue has an inner diameter surface facing radially inward, and
the inner diameter surface is tilted so as to be gradually positioned radially inward as a distance from the tip increases.
   (3)

The ball screw device according to (1) or (2) in which the tip is disposed on the inner peripheral raceway surface of the nut.

(4)

The ball screw device according to any one of (1) to (3) in which
the circulation groove surface is an S-shaped groove surface formed in an S-shape.

The S-shaped groove surface includes:
a spiral area disposed near the deflector opening and extending along a spiral direction in which the raceway extends, and
a bent area adjacent to the spiral area and gradually deviating from the spiral direction.

The tip is disposed radially outside with respect to the spiral area.

(5)

The ball screw device according to any one of (1) to (3) in which
the circulation groove surface is an S-shaped groove surface formed in an S-shape.

The S-shaped groove surface includes:
a spiral area disposed near the deflector opening and extending along a spiral direction in which the raceway extends, and
a bent area adjacent to the spiral area and gradually deviating from the spiral direction.

The tip is disposed radially outside with respect to the bent area.

(6)

The ball screw device according to any one of (1) to (5) in which
the circulation groove surface is an S-shaped groove surface formed in an S-shape.

When viewed from a radial outside of the screw shaft, the recess and the deflector have a length in an intersecting direction crossing an axial direction longer than a length in the axial direction parallel to the screw shaft.

(7)

The ball screw device according to any one of (1) to (3) in which
the circulation groove surface extends in a reverse spiral direction opposite to a spiral direction in which the raceway extends.
   (8)

The ball screw device according to any one of (1) to (7) in which
the outer peripheral raceway surface has a thread height that is greater than a thread height of the inner peripheral raceway surface.
   (9)

The ball screw device according to any one of (1) to (8) in which
the circulation groove surface includes:
a pair of inlet/outlet groove surfaces disposed at both ends in an extending direction of the circulation groove surface and extending in a circumferential direction from the deflector openings, and
a concave surface in which the plurality of balls sinks radially inward. The concave surface is disposed between the pair of inlet/outlet groove surfaces.
   (10)

The ball screw device according to any one of (1) to (8) in which
the circulation groove surface includes a concave surface in which the plurality of balls sinks radially inward, and
the concave surface is linear when viewed in the axial direction.
   (11)

The ball screw device according to any one of (1) to (10) in which
the deflector opening has a groove shape larger than a groove shape of the screw shaft opening.

### REFERENCE SIGNS LIST

1, 1001 BALL SCREW DEVICE
2, 1002 SCREW SHAFT
3, 1003 NUT
4, 1004 BALL
5, 205, 305, 405, 505, 605, 705, 1005, 2005 DEFLECTOR
6 NUT BODY
6a, 1006a INNER PERIPHERAL RACEWAY SURFACE
6c, 1006c SCREW THREAD
6e GROOVE SHOULDER
6f OPPOSING CONTACT PORTION
8 RACEWAY
11 SCREW SHAFT BODY
13 OUTER PERIPHERAL RACEWAY SURFACE
13a SCREW THREAD
13b SCREW SHAFT OPENING
13c GROOVE SHOULDER
14 RECESS
15 FIRST OPPOSING SURFACE
16 SECOND OPPOSING SURFACE
18 THIN PORTION
20 OUTER DIAMETER SURFACE
21, 1021, 2021 S-SHAPED GROOVE SURFACE (CIRCULATION GROOVE SURFACE)
25 FIRST SIDE SURFACE
26 SECOND SIDE SURFACE
29 GUIDE CONTACT PORTION
30 CENTRAL GROOVE SURFACE
31 INLET/OUTLET GROOVE SURFACE
32 DEFLECTOR OPENING
33 BENT GROOVE SURFACE
40 TONGUE
100 BRAKE CALIPER
104 ELECTRIC ACTUATOR
120 HOUSING

1. A ball screw device comprising:
a nut that has an inner peripheral raceway surface on an inner peripheral surface;
a screw shaft that is inserted into the nut and has an outer peripheral raceway surface on an outer peripheral surface;
a plurality of balls disposed on a raceway between the outer peripheral raceway surface and the inner peripheral raceway surface; and
at least one deflector that circulates the plurality of balls, wherein
the outer peripheral surface of the screw shaft is provided with at least one recess that is recessed radially inward and accommodates the deflector,
the recess has an inner peripheral surface provided with two screw shaft openings in the outer peripheral raceway surface, the two screw shaft openings opened toward the deflector,
the deflector includes:
a pair of deflector openings opened in an outer peripheral surface of the deflector and connected to the two screw shaft openings,
a circulation groove surface that is connected to each of the pair of deflector openings and has an internal space forming a circulation pathway, and
a pair of tongues disposed radially outside the circulation groove surface and protruding toward the pair of deflector openings, and
the pair of tongues each has a tip disposed radially outside a virtual spiral connecting centers of the plurality of balls rolling on the raceway.

2. The ball screw device according to claim 1, wherein
the pair of tongues each has an inner diameter surface facing radially inward, and
the inner diameter surface is tilted so as to be gradually positioned radially inward as a distance from the tip increases.

3. The ball screw device according to claim 1, wherein
the tip is disposed on the inner peripheral raceway surface of the nut.

4. The ball screw device according to claim 1, wherein
the circulation groove surface is an S-shaped groove surface formed in an S-shape, the S-shaped groove surface includes:
a spiral area disposed near each of the pair of deflector openings and extending along a spiral direction in which the raceway extends, and
a bent area adjacent to the spiral area and gradually deviating from the spiral direction, and
the tip is disposed radially outside with respect to the spiral area.

5. The ball screw device according to claim 1, wherein
the circulation groove surface is an S-shaped groove surface formed in an S-shape,
the S-shaped groove surface includes:
a spiral area disposed near each of the pair of deflector openings and extending along a spiral direction in which the raceway extends, and
a bent area adjacent to the spiral area and gradually deviating from the spiral direction, and
the tip is disposed radially outside with respect to the bent area.

6. : The ball screw device according to claim 1, wherein
the circulation groove surface is an S-shaped groove surface formed in an S-shape, and
when viewed from a radial outside of the screw shaft, the recess and the deflector have a length in an intersecting direction crossing an axial direction longer than a length in the axial direction parallel to the screw shaft.

7. The ball screw device according to claim 1, wherein
the circulation groove surface extends in a reverse spiral direction opposite to a spiral direction in which the raceway extends.

8. The ball screw device according claim 1, wherein
the outer peripheral raceway surface has a thread height that is greater than a thread height of the inner peripheral raceway surface.

9. The ball screw device according to claim 1, wherein
the circulation groove surface includes:
a pair of inlet/outlet groove surfaces disposed at both ends in an extending direction of the circulation groove surface, the pair of inlet/outlet groove surfaces extending in a circumferential direction from the pair of deflector openings, and
a concave surface in which the plurality of balls sinks radially inward, the concave surface being disposed between the pair of inlet/outlet groove surfaces.

10. The ball screw device according to claim 1, wherein
the circulation groove surface is composed only of a concave surface in which the plurality of balls sinks radially inward, and
the concave surface is linear when viewed in the axial direction.

11. The ball screw device according to claim 1, wherein
the pair of deflector openings has a groove shape larger than a groove shape of the two screw shaft openings.

12. The ball screw device according to claim 1, wherein
when viewed from a radial outside of the deflector, a direction orthogonal to an axis of the screw shaft is defined as an intersecting direction,
a side away from the axis in the intersecting direction is defined as an outer side in the intersecting direction, and
the tip is disposed on the outer side in the intersecting direction from the recess.

13. The ball screw device according to claim 7, wherein
the circulation groove surface extends in an extending direction, and an entire portion from one end to an other end of the circulation groove surface in the extending direction extends in the reverse spiral direction.

14. The ball screw device according to claim 9, wherein
the inlet/outlet groove surface has a groove bottom at a constant distance from the axis of the screw shaft.

15. The ball screw device according to claim 1, wherein
the circulation groove surface only includes a concave surface in which the plurality of balls sinks radially inward, and
the concave surface has an arc shape when viewed in an axial direction.

16. The ball screw device according to claim 1, wherein
the pair of tongues is spaced apart from each other in an axial direction, and
an opening that opens the circulation pathway radially outward is formed between the pair of tongues.

17. The ball screw device according to claim 1, wherein
the plurality of balls moving on the circulation groove surface has a maximum radial movement amount smaller than a diameter of each of the plurality of balls.
